(19) United States
(12) Patent Application Publication
(10) Pub. No.: US 2013/0014018 A1
(43) Pub. Date: Jan. 10, 2013

(54) SYSTEM AND METHOD FOR SELECTING, TRACKING, AND/OR INCREASING ACCESSIBILITY TO TARGET ASSETS ON A COMPUTER NETWORK

(76) Inventor: Madison C. Miner, Bellingham, WA (US)

(21) Appl. No.: 13/546,935

(22) Filed: Jul. 11, 2012

Related U.S. Application Data
(63) Continuation of application No. 12/552,494, filed on Sep. 2, 2009, now abandoned.
(60) Provisional application No. 61/190,548, filed on Sep. 2, 2008.

(51) Int. Cl. G06F 15/16; G06F 15/177

(52) U.S. Cl. 715/736; 709/224

(57) ABSTRACT

A system increasing accessibility to assets accessible on a computer network, comprises a target asset selecting engine, a memory storage device, and a rendering engine. The target asset selecting engine allows at least one asset accessible over the computer network to be identified as a target asset and generates target asset data associated with the at least one target asset, where the target asset data includes asset files associated with the appearance of the at least one target asset. The memory storage device stores target asset data. The rendering engine generates a target asset representation for each target asset based on the target asset data stored in the memory storage device. Each target asset representation substantially matches the appearance of the target asset associated therewith.

### RELATED APPLICATIONS

This application (Attorney's Ref. No. P217001) is a continuation of U.S. patent application Ser. No. 12/552,494 filed Sep. 2, 2009.

U.S. patent application Ser. No. 12/552,494 claims priority of U.S. Provisional Application Ser. No. 61/190,548 filed Sep. 2, 2008.

The contents of all related applications listed above are incorporated herein by reference.

### TECHNICAL FIELD

The present invention relates to the systems and methods for organizing data available on computer networks and, more particularly, to systems and methods for selecting, tracking, and/or accessing data available on computer networks such as the Internet.

### BACKGROUND

Computer networks, such as the Internet, comprise uniquely identifiable computing devices that store data and, at a minimum, allow other computing devices connected to the network to access at least some of the stored data. The term “data” is used herein to refer to any information that may be stored, processed, and/or transmitted in electronic form. The term “store” is used herein to refer to the act of copying data to a volatile or non-volatile data storage device. The term “process” is used herein to refer the modification of a unit of data or to the creation of additional data based on other data. The term “transmission” is used herein to refer to the transference of data from one computing device to another computing device.

The term “computing device” will be used herein to refer to a combination of hardware and software capable of performing tasks such as storing, formatting, modifying, and/or transmitting data. Examples of computing devices include web servers, computer workstations, laptop computers, and mobile phones. Typically, a computing device will allow a user to perceive data (via a display, audio system, printer, etc.) and/or input data (via a keyboard, mouse, microphone, etc.).

The term “website” will be used herein to refer to a computing device that stores data and is connected to a computer network such that the stored data is accessible to other computing devices on the computer network. A website typically comprises at least one, and typically more than one, “webpage” that represent formatted data. The term “client device” will be used herein to refer to a computing device that is connected to a computer network and is, at a minimum, capable of accessing data stored on a website. The term “access” is used herein to include the ability to store, perceive, and interact with data; in the context of a client device and a website, accessing data typically includes the transmission of data between the website and the client device. Information embodied as data may include words, formatting, graphics, sounds, and other elements that facilitate the understanding of the information to be conveyed through the data.

Typically, websites and client devices adhere to standards to facilitate the transmission of data between the website and the client device and the perception of and interaction with the data by the user of the client device. For example, a client device may use an industry standard browser, and a website may be configured to allow the user of such an industry standard browser to access data accessible through the website.

The data accessible through a website often changes over time. For example, on a commercial website offering items for sale, the items for sale and the prices of these items may change daily, hourly, or even minutely. The operator of a commercial website offering items for sale thus typically has the ability to change the data on the website, either by hand or programmatically, to reflect these changes.

From the perspective of the user of a client device, a computer network may be viewed as a collection of assets. The term “asset” is used herein to refer to a package of data made accessible by a website over the computer network. Typically, any particular user of a client device will have interest in a limited number of assets from the enormous collection of assets available on the computer network.

The term “target asset” will be used to refer to an asset available on the computer network in which a particular client device user has an interest. One example of a target asset is an item offered for sale by a commercial website, including the price of the item and/or the formatting used by the commercial website to display the item and price. Another example of a target asset is a particular location and weather conditions at that location, which might be of interest to a skier, snowboarder, or surfer. Other examples of target assets include stock prices, financial information, forum information, news, and the like.

Accordingly, although users of client devices may have access to an enormous amount of information in the form of assets available over computer networks such as the Internet, such users typically develop a set of target assets in which the user has particular interest. As generally described above, assets, including target assets, may change as the information associated with that asset changes. Because the user of a client device may want to be informed of any changes in target assets, client device users may feel compelled frequently to visit websites containing target assets to determine whether the target asset has changed. A user thus may waste time viewing target assets that have not changed or not discover changes in target assets in a timely fashion.

For certain target assets, the website containing the target asset may be configured such that the user may register with the website such that the user is automatically informed of changes in the target asset. As examples, the operator of a website may use technologies such as RSS feeds and/or WebSlices to increase accessibility to information by notifying users that a target asset has changed.

However, the implementation of technologies such as RSS feeds and WebSlices is nontrivial, and many, if not most, websites do not allow users to receive automatic notification of changes in assets available through the website. Further, for a variety of reasons, the client device user may not want to register with every website containing a target asset.

Accordingly, the need exists for systems and methods for selecting target assets and monitoring selected target assets to increase accessibility to the target assets. This need is of particular significance when the target asset is located on a website that does not include a system for tracking target assets or where the use of available systems to track target assets is undesirable for any reason.

### SUMMARY

The present invention may be embodied as a system increasing accessibility to assets accessible on a computer network. A plurality of target websites are accessible over the computer network. The plurality of target websites are stored on a plurality of web servers connected to the computer network. Each of the plurality of target websites contains at least one target asset. Each of the plurality of target websites also defines an appearance of the target assets. A target asset selecting engine is connected to the computer network. The target asset selecting engine allows at least one asset accessible over the computer network to be identified as a target asset and generates target asset data associated with the at least one target asset, where the target asset data includes asset files associated with the appearance of the at least one target asset. A memory storage device is connected to the computer network. The memory storage device stores the target asset data. A rendering engine is also connected to the computer network. The rendering engine generates a target asset representation for each target asset based on the target asset data stored in the memory storage device. Each target asset representation substantially matches the appearance of the target asset associated therewith. A plurality of computing devices is connected to the computer network. The computing devices allow the plurality of users to display the target asset representations.

The present invention may also be embodied as a system for increasing accessibility to target assets associated with a target webpage accessible over a computer network. The system comprises a target asset selection engine, a memory storage device, and a rendering engine. The target asset selecting engine generates a representation of the target webpage containing the target asset, allows a portion of the target webpage to be selected as the target asset based on the representation of the target webpage, and generates target asset data associated with the target asset, where the target asset data includes asset files associated with the appearance of the target asset. The memory storage device stores the target asset data. The rendering engine is connected to the computer network. The rendering engine generates a target asset representation for each target asset based on the target asset data stored in the memory storage device. Each target asset representation substantially matches the appearance of the target asset associated therewith.

### BRIEF DESCRIPTION OF THE DRAWINGS

FIG. 1 is a block diagram illustrating an example of a target asset selection and monitoring system and the environment in which that system is intended to be used;

FIG. 2 is a block diagram illustrating an example of a server-based system for implementing the principles of the present invention and the environment in which that server-based-system is intended to be used;

FIG. 3 is a flow diagram illustrating one possible method of selecting a target asset using the principles of the present invention embodied as a server-based system;

FIGS. 4A-4E are screen shots illustrating an example interface for allowing a user to select a target asset using a server-based system;

FIG. 5 is a block diagram illustrating an example of a client-based system for implementing the principles of the present invention and the environment in which that client-based system is intended to be used;

FIG. 6 is a flow diagram illustrating one possible method of selecting a target asset using the principles of the present invention embodied as a client-based system;

FIGS. 7A-7D are screen shots illustrating an example interface for allowing a user to select a target asset using a client-based system;

FIG. 8 is a block diagram illustrating an example of a distributed system for implementing the principles of the present invention and the environment in which that distributed system is intended to be used;

FIG. 9 is a flow diagram illustrating one possible method of selecting a target asset using the principles of the present invention embodied as a distributed system; and

FIG. 10 is a flow diagram illustrating one possible method of obtaining the status of a target asset selected using either a server-based system or a client-based system.

### DETAILED DESCRIPTION

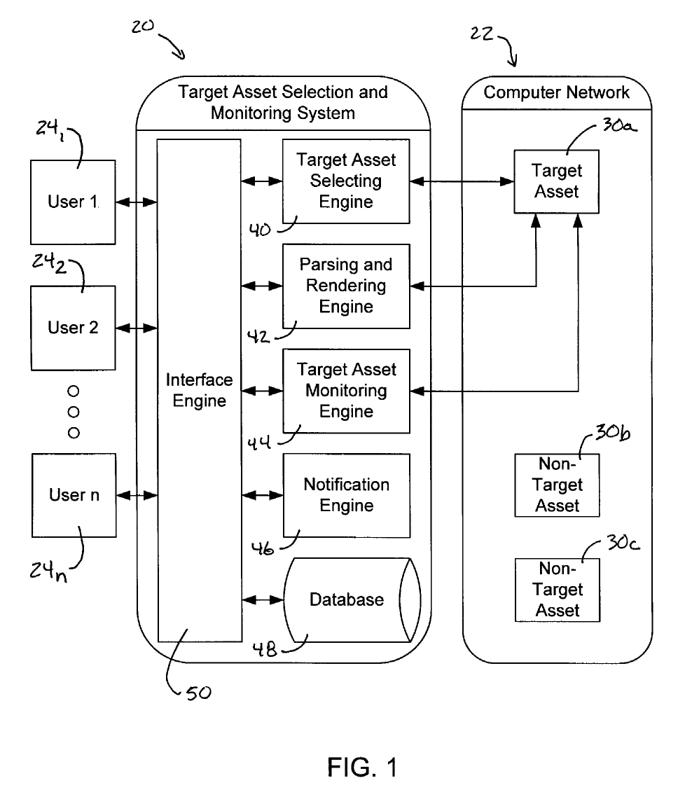

Referring initially to FIG. 1 of the drawing, depicted at 20 therein is an example of a target asset selection and monitoring system of the present invention. The example system 20 is connected to a computer network 22; the system 20 is used by one or more users operating computing devices 24₁, 24₂, and 24ₙ also connected to the network 22. In the following discussion, the term “user” will be used to refer both to the individual operating the computing devices 24 and to the computing device itself.

The computer network 22 may be any communications network that allows the transmission of data between computing devices connected to the network 22. One relevant example of a communications network that may be used as the example computer network 22 is the Internet.

The example system 20 allows the users 24 to select and monitor a target asset 30a accessible using the computer network 22. The computer network 22 typically comprises assets in addition to the target asset 30a, and two examples of non-target assets 30b and 30c are depicted in FIG. 1. For purposes of clarity, FIG. 1 represents a trivial example containing only three assets (one target asset 30a and two non-target assets 30b and 30c). One of ordinary skill in the art will recognize that the computer network 22 will typically comprise many more than three assets and more than one target asset.

The example target asset selection and monitoring system 20 comprises a target asset selecting engine 40, a parsing and rendering engine 42, a target asset monitoring engine 44, a notification engine 46, and a data storage device in the form of a database 48.

The example target asset selection and monitoring system 20 further comprises an interface engine 50 for implementing logic that allows the users 24 to operate the target asset selecting engine 40 and to enter data for use by the parsing and rendering engine 42, target asset monitoring engine 44, and notification engine 46. Data entered through or generated by the target asset selecting engine 40, parsing and rendering engine 42, target asset monitoring engine 44, notification engine 46, and interface engine 50 may be stored in the database 48.

The example interface engine 50 may also be configured to define a user interface (UI) presented to the users 24 and/or an application programming interface (API) for making functions of the system 20 available to third party applications. If a third party application accesses functions of the system 20 through an API defined by the interface engine 50, the users 24 may view a UI generated by the third party application and not the interface engine 50.

To use the system 20, the users 24 first use the target asset selecting engine 40 to select or identify the target asset 30a from the plurality of assets available on the computer network 22. The target asset selecting engine 40 records or generates target asset data associated with the target asset, such as a target asset path to the target asset that may be used to relocate the target asset.

The parsing and rendering engine 42 records or generates a target asset representation corresponding to the target asset 30a. The target asset representation may be used in the process of selecting, displaying, and monitoring the target asset 30a. The target asset representation may also be stored as a file in the database 48.

At an initial point in time, the asset monitoring engine 44 obtains an initial state value set comprising at least one state value from the target asset 30a and stores the initial state value set in the database 48. The initial state value set thus represents or corresponds to the state of the target asset 30a at the initial point in time.

At a subsequent point in time after the initial point in time, the target asset monitoring engine 44 visits the target asset 30a and obtains, at a subsequent point in time, a subsequent state value set. The subsequent state value set corresponds to the state of the target asset 30a at the subsequent point in time.

The target asset selecting and monitoring system 20 compares initial state value set with one or more subsequent state value sets to determine if the state of the target asset 30a has changed. In the example system 20, the target asset monitoring engine 44, notification engine 46, or interface engine 50 will determine whether the subsequent set of state values falls within change parameters defined with reference to the initial set of state values.

The system 20 takes no action as long as the states of the target asset 30a at the initial and the subsequent point in time are equivalent. The term “equivalent” is used herein to indicate that the target asset 30a, or a relevant portion of the target asset 30a, is still within a set of change parameters. The change parameters may be predetermined and/or selected by the user 24 through a set of options presented by the interface engine 50.

As examples, the set of change parameters could simply correspond to or indicate the absence of a parameter that is subsequently added (e.g., the word “sold” originally not present on the target asset but added later), could correspond to a direction of change of a value (a price that is decreased as opposed to a price that stays the same or increases), could correspond to a value that is subsequently changed (e.g., a price of $10.00 subsequently changed to any other price), and/or could correspond to a range of values (e.g., temperature at a location exceeds 70° F.). In addition to alphanumeric state values, the state values may be or be associated with graphics, video, or the like forming at least a portion of the target asset 30a.

If, however, the notification engine 46 determines that the states of the target asset 30a at the initial and subsequent points in time are not equivalent, the notification engine 46 sends a change notice to the user 24 associated with the target asset 30a. In this case, the term “not equivalent” indicates that a relevant portion of the target asset 30a, such as one or more value in the set of state values, is no longer within the set of change parameters.

The change notice may simply direct the user 24 back to the target asset so that the user 24 can view the change. In addition or instead, the change notice may contain data that illustrates the nature of the change in the target asset 30a. The change notice may take the form of an email, text message, pop-up message, sound, and/or other method of altering the user computing device 24 to indicate to the user that the status of the target asset 30a has changed.

Upon receipt of the change notice, the change in the target asset 30a is brought to the attention of the user 24 associated with the target asset 30a. After the user 24 configures the system 20 to monitor the target asset 30a, the target asset selection and monitoring system 20 informs the user 24 that the status of the target asset 30a has changed without further input by the user 24. The system 20 obviates the need for the user 24 to know in advance when the state of the target asset 30a has changed and/or to visit the target asset 30a to determine whether the status of the target asset 30a has changed.

With the foregoing general understanding of the operation of the target asset selection and monitoring system 20, the details of several representative examples of the present invention will now be described.

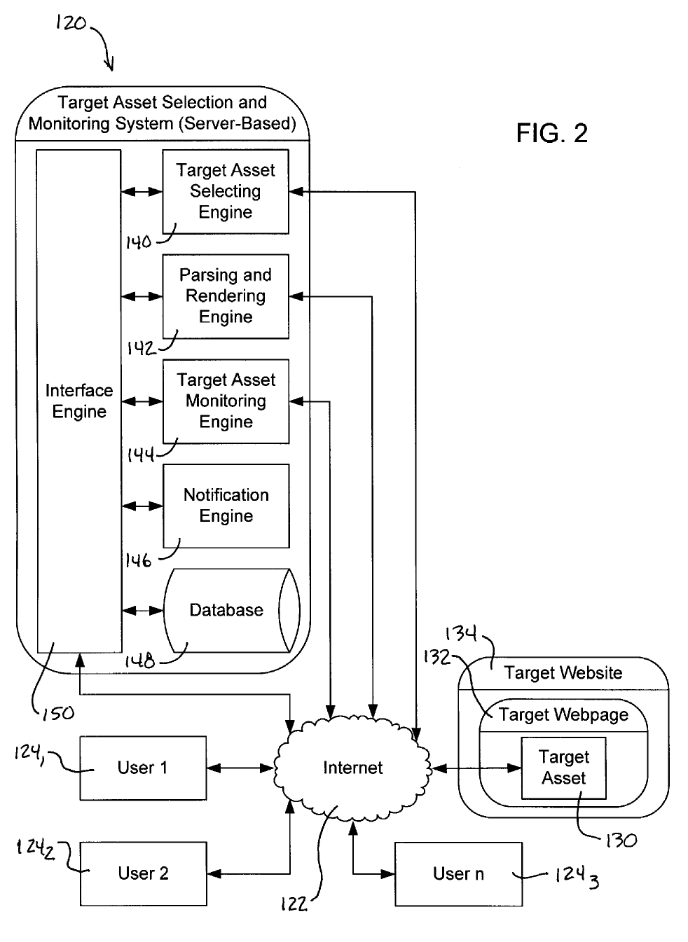

Referring now to FIG. 2, depicted therein is a second example of a target asset selection and monitoring system 120 constructed in accordance with, and embodying, the principles of the present invention. The example system 120 takes the form of a server connected to a computer network 122 in the form of the Internet; the example system 120 will be referred to herein as a server-based target asset selection and monitoring system. One or more users 124₁, 124₂, and 124₃ are also connected to the computer network 122.

The server forming the target asset selection and monitoring system 120 may be one single application or various pieces of software working together. As will be described in further detail below, the example system 120 is depicted as the combination of separate engines. Additionally, the example system 120 may be implemented on a single server, on a plurality of task specific servers (e.g., a database server and a web server), a plurality of redundant servers, or using another configuration of servers.

FIG. 2 also illustrates a target asset 130. As generally discussed above, the computer network 122 will typically comprise many assets in addition to the target asset 130, but only the target asset 130 is illustrated in FIG. 2 for clarity. Additionally, two or more of the assets accessible using the computer network 122 may be target assets, but only one target asset is depicted in FIG. 2, again for purposes of clarity.

Commonly, the target asset 130 will form a part of a target webpage 132 that in turn forms a part of a target website 134. The target website 134 may comprise a plurality of webpages, but the target asset 130 is associated only with one of those webpages. However, a separate target asset may be identified with another of the webpages forming part of the target website 134.

Each user 124 may be configured as a computer running an industry standard browser program configured to view a host website associated with the server forming the target asset selection and monitoring system 120. As shown in FIG. 2, the users may visit the host website associated with the system 120 to use the services provided by that system 120 as will be described below.

The example target asset selection and monitoring system 120 comprises a target asset selecting engine 140, a parsing and rendering engine 142, a target asset monitoring engine 144, a notification engine 146, and a data storage device in the form of a database 148.

The example target asset selection and monitoring system 120 further comprises an interface engine 150 that implements logic that allows the users 124 to operate the target asset selecting engine 140 and which allows the users 124 to enter data used by the parsing and rendering engine 142, target asset monitoring engine 144, notification engine 146, and database 148.

The example interface engine 150 may also be configured to define a user interface (UI) presented to the users 124 and/or an application programming interface (API) for making functions of the system 120 available to third party applications. If a third party application accesses functions of the system 120 through an API defined by the interface engine 150, the users 124 may view a UI generated by the third party application and not the interface engine 150.

More specifically, the interface engine 150 may be or comprise a web engine that defines a user interface for the host website associated with the target asset selection and monitoring system 120. Through the user interface, the interface engine 150 allows the users 124 to perform tasks including, but not limited to, the following tasks:
1. create an account (and/or become a member);
2. create or design a custom page containing one or more target assets 130; and/or
3. select how the user would like to increase their accessibility to target assets 130;

Through the user interface presented by the interface engine 150, the user operates the target asset selecting engine 140 to select, modify and delete target assets 130. As the user operates the target asset selecting engine 140, the engine 140 will typically record a target asset path associated with the target asset.

The parsing and rendering engine 142 generates a target asset file for each target asset selected or identified using the target asset selecting engine 140. The target asset file typically contains data corresponding to the look and feel of the target assets 130. In particular, Appendix A attached hereto contains an example of original HTML code from an example target website; Appendix B attached hereto contains an example of representative HTML code that may form a part of the target asset file generated by the rendering and parsing engine. The representative HTML code in Appendix B can be used to create a display image similar to a target asset forming part of the example target webpage represented by the original HTML code in Appendix A.

The interface engine 150 may use the target asset file to generate at least a portion of the user interface presented to the user 124 such that at least a portion of the user interface represents and/or resembles the target asset 130. By presenting a user interface based at least in part on the target asset file, the interface engine facilitates the selection and monitoring of target assets 130.

The target asset monitoring engine 144 checks the status of each target asset by “scraping” the target asset to obtain one or more state values associated with the target asset. The state values may be any quantity associated with a target asset, and examples of state values include the price of an item and the temperature of a geographical location.

The target asset monitoring engine 144 obtains one or more state values from each target asset at different points in time to allow the system 120 to determine whether the status of the target asset has changed. The target asset monitoring engine 144 may optionally store state values associated with target assets in the database 148 for further analysis as will be described in further detail below.

Typically, the target asset monitoring engine 144 will scrape the target asset 130 at multiple points in time. As examples, the target asset monitoring engine 144 may scrape the target assets at a monitoring schedule based on a periodic interval specified by the user (e.g., every 5 or 10 minutes), specific times specified by the user (e.g. at 8 am and 11 am every weekday), and/or as determined by the engine 144.

The target asset monitoring engine 144 may be programmed to determine the optimum monitoring schedule for scraping a given target asset based on comparisons of state values associated with the target asset stored overtime. For example, an analysis of state values over time may indicate that the status of a given target asset is more likely to change at a certain time of day, in which case the engine 144 will scrape the target asset shortly after that time each day. In another situation, the engine 144 might determine that the state values associated with a target asset are not changed in accordance with a predetermined schedule, and the values must be checked periodically. Accordingly, the engine 144 may be programmed to monitor target assets to create one or more monitoring schedules for each monitored target asset based on stored state values associated with the target assets.

In general, a comparison of a status value associated with a given target asset at a first point in time with the same status value of the given target asset at a second point in time allows the system 120 to determine whether the status of any given target asset 130 has changed. Typically, any change in the same status value between two different points in time will indicate that the status of the target asset has changed.

In the example system 120, the comparison of the state values may be performed by the target asset monitoring engine 144, by the notification engine 146, or by the interface engine 150. If the target asset monitoring engine 144 performs the comparison, the comparison will likely be performed in accordance with the user-defined or programmatically determined monitoring schedule. If the notification engine 146 performs the comparison, the comparison can be made according to a notification schedule. The notification schedule may be predetermined or defined by the user.

Once the system 120 determines that the status of the target asset has changed, the notification engine 146 will send a change notice to the user 124. The notification engine 146 can be programmed to send a change notice as soon as a change is detected or based on a notification schedule that can be predetermined or defined by the user.

In addition to the asset file and/or the state values, the database 148 will typically store user information, such as email address, password, name, target asset information, such as target asset path, and any other information that needs to be persisted.

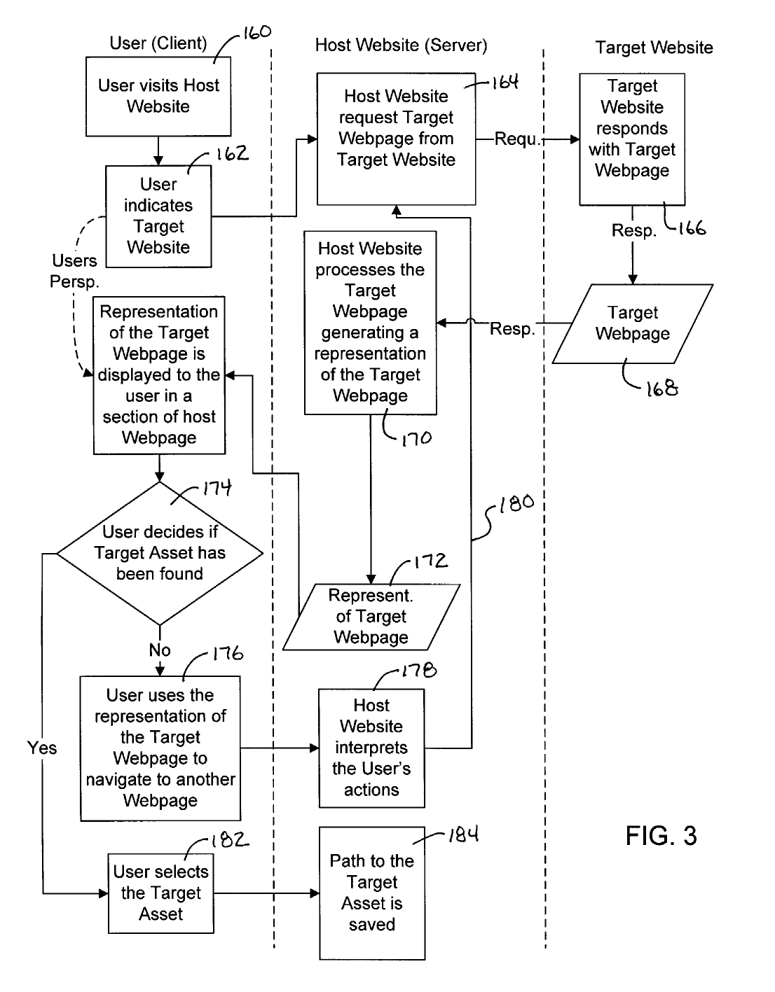

Referring now to FIG. 3, depicted therein is an example of a method of selecting a target asset that might be employed by a server-based target asset selection and monitoring system such as that depicted in FIG. 2 above.

At an initial step 160, the user visits the host website associated with a target asset selection and monitoring system. At step 162, the user indicates a target website to the host website, possibly by entering the URL or clicking on an element (link, picture, etc.). The host website will record the target website URL as potentially becoming the starting point of a target asset path. At step 164, the host website requests the target webpage from the target website; this request will typically use an HTTP GET action.

At step 166, the target website responds to the host website by providing the target webpage 168. At step 170, the host website processes the target webpage by generating a representation 172 of the target webpage 168. In one example method of the present invention, the user may navigate using the representation of the target webpage. To accomplish this, the host website can display the representation of the target webpage in a section or frame of user interface defined by the host website. In this case, the host website could create a web-based web browser to show a navigatable representation of the target webpage in a section of user interface defined by the host website.

One possible method of creating a navigatable representation, commonly referred to as a proxy, of the target webpage is to modify the contents of the target webpage using one or more of the procedures described below:
1. the server-based system could modify any elements contained in the target webpage that point to external data (such as images. backgrounds, style sheets, script files, etc.), so that the element points absolutely to the original target website (instead of relatively) or the host website could download the external data and change the element to point at the host website's downloaded copy of the data;
2. the server-based system could remove or modify any elements, such as scripts, embedded objects, applets, and meta tags, contained in the target webpage that might allow or initiate navigation away from the host website, so that these elements will not allow or initiate navigate away from the host website;
3. the server-based system could modify or remove all meta tags containing a redirect, so the meta tag redirects to the host website and not to the target website;
4. the server-based system could modify or remove all forms so that when the forms are submitted they post to the host website and not the target website; and/or
5. the server-based system could modify all anchor tags so their “href’ attribute points to the host website and not the target website.

Another possible method for the host website to create a navigatable representation of the target webpage would be to provide an image representing the target webpage. One possible method of creating an image representing the target webpage's user interface is as follows:
1. the host website loads the target webpage into a Web Browser and takes a screen shot of the rendered target webpage's user interface;
2. the host website then sends the representation of the target webpage to the user;
3. the host website displays the representation of the target webpage to the user in a section of the user interface of the host website (the representation may appear very similar to the user as the original target website or the representation may look substantially different);

Returning back to the method depicted in FIG. 3, the user next confirms at step 174 whether a target asset has been located. The user may indicate that a target asset has been located by pressing a button in the user interface of the host website.

If at step 174 the user indicates that a target asset has not been located, at step 176 the user may use the representation of the target webpage to navigate to another target webpage or specify another target webpage by other means.

If the user uses the representation of the target webpage to navigate, at step 178 the host website interprets the user's actions to determine to what webpage or target asset the user would like to navigate. Possible user actions that the host website may use to discern the user's desired destination include:
1. determining what link the user clicked, if any;
2. determining what form information the user submitted, if any; and/or
3. determining if the user clicked an image, as well the location one the image that was clicked.

If the user navigates using the representation of the target webpage, at step 180 the host website returns to step 164 and generates another request for a target webpage from the target website. The host website will record the properties of the new request (again typically involving an HTTP GET or POST action) as these properties may potentially become part of a target asset path.

The process again proceeds to step 174 to as described above. This process is repeated until the user confirms at step 174 that a target asset has been found. Once the user confirms that a target asset has been found, the user selects the target asset at step 182. Possible methods for selecting the target asset include clicking once on the target asset, clicking and dragging to select an area of the target webpage containing the target asset, and/or indicating that the entire target webpage is a target asset.

Once the user has selected the target asset, at step 184 the host website records and saves the target asset path associated with the target asset. After the user has selected the target asset, the host website will ask the user to choose any options for increasing the availability of the target asset to the user.

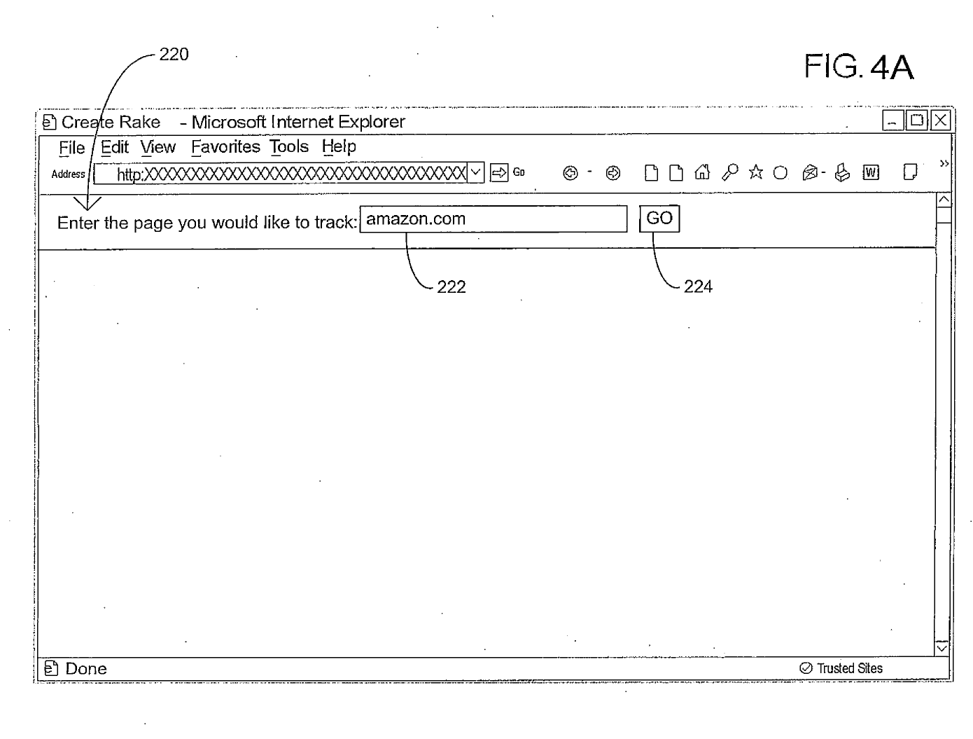

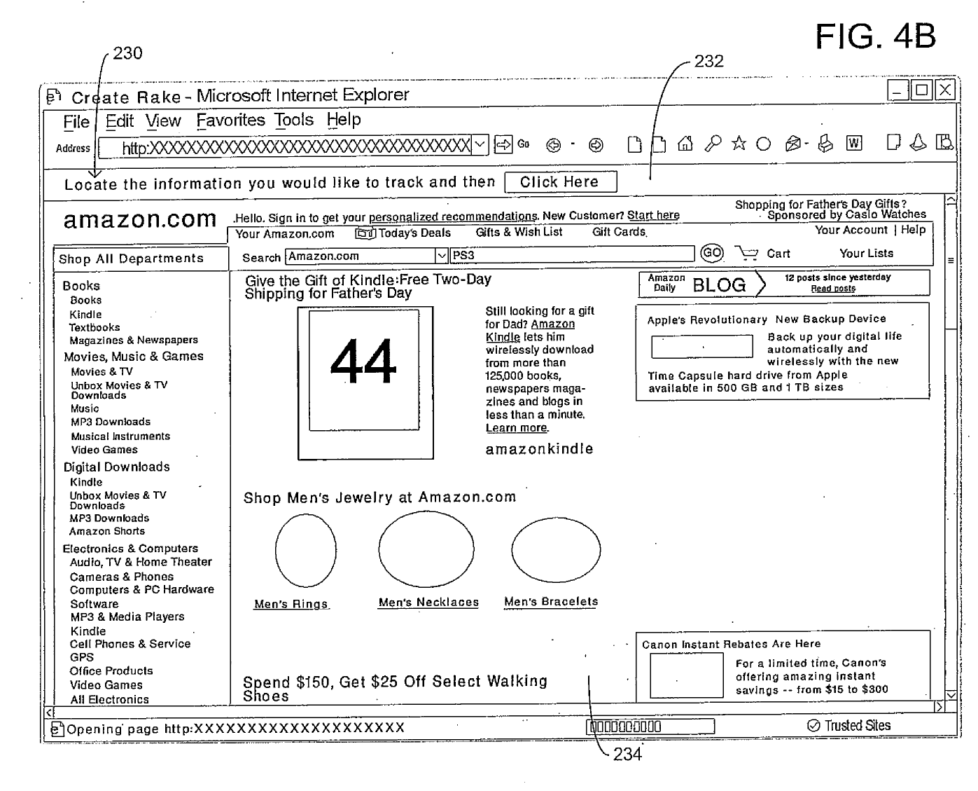

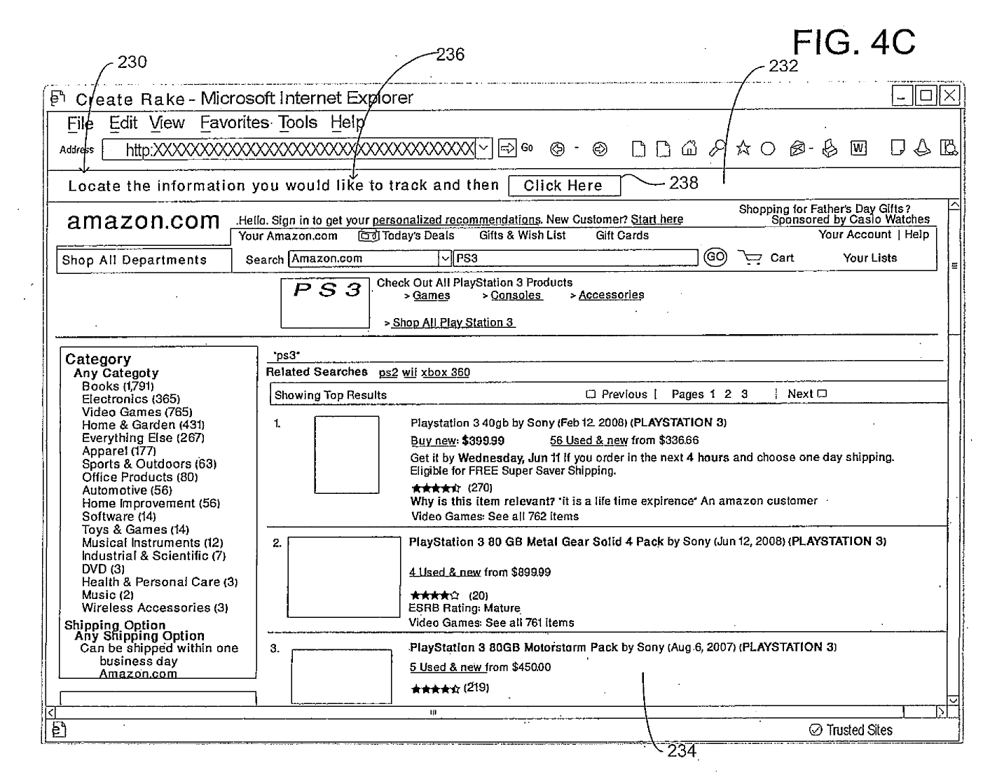

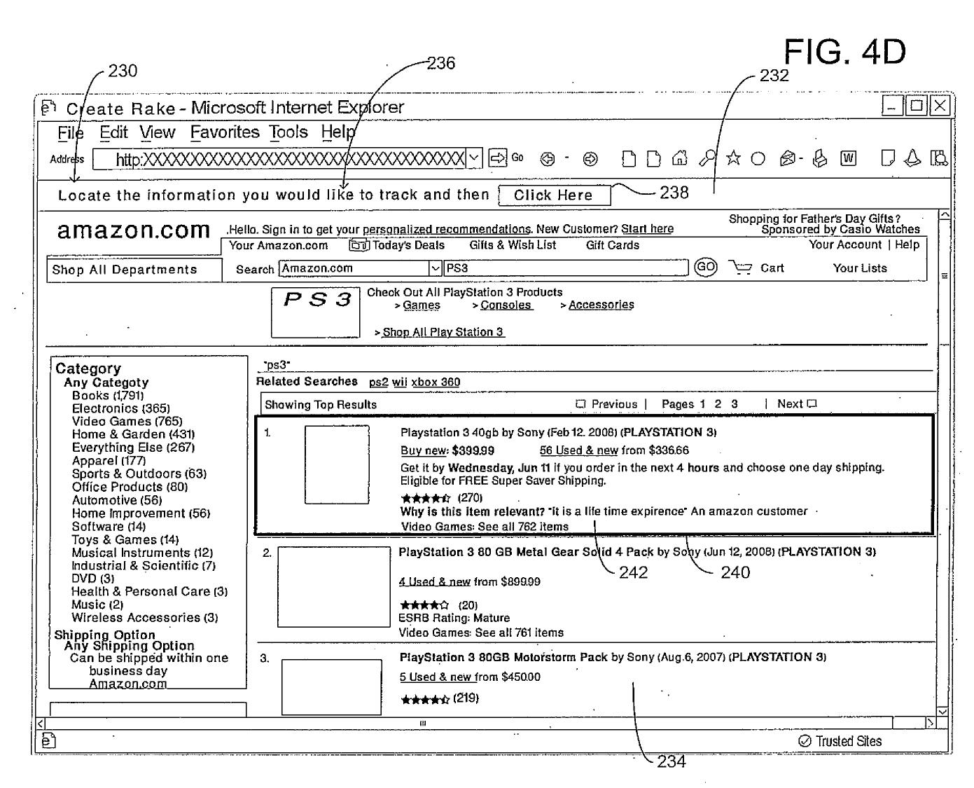

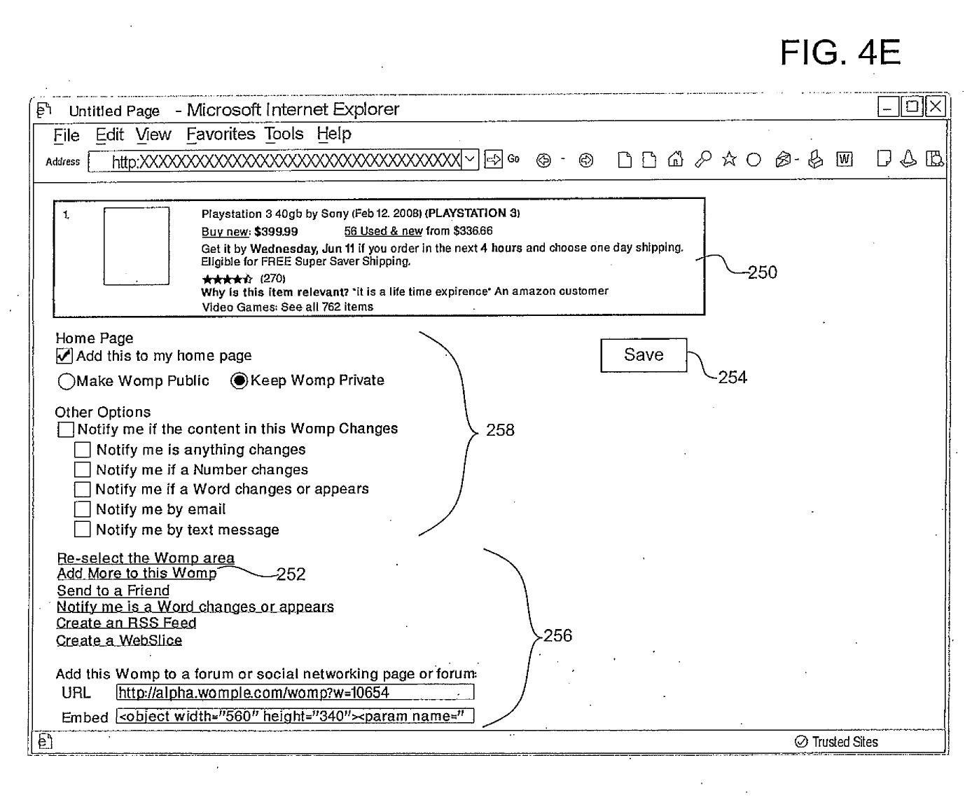

Referring now to FIGS. 4A-4E, an example of a user interface that might be presented by a server-based target asset selection and monitoring system such as that depicted in FIG. 2 or by a method of selecting a target asset such as that depicted in FIG. 3. In particular, FIGS. 4A-4E contain a series of screen shots illustrating the process of identifying a target asset and selecting options for monitoring the target asset and generating change notices for changes in status associated with the target asset.

In a navigation panel 220 shown in FIG. 4A, the user enters the URL of is the target website or target webpage into a textbox 222. In the example navigation panel 220, the user has entered “Amazon.com” in the box 222. The user then clicks on a GO button 224, at which point the user interface displays a selection panel 230 comprising a control portion 232 and a display portion 234 as shown in FIG. 4B.

A representation of the target website is displayed in the display portion 234 of the selection panel 230. Using the representation of the target website, the user navigates to a target webpage within the target website as shown in FIG. 4C. In this case, the user enters “PS3” in the search field associated with the target website and presses the GO button associated with the target website. A representation of the target webpage is then displayed in the display portion 234 of the selection panel 230.

The control portion 232 contains instruction text 236 and a Click Here button 238. As instructed by the instruction text 236, the user identifies the target asset on the target webpage, if it exists, and uses the curser to draw a box 240 around a portion of the representation of the target webpage in the display portion 234 as shown in FIG. 4D. In the example shown, after the user indicates that a target asset has been located, the cursor changes to crosshairs, and the user can click and drag to select an area of the page containing the target asset. In the example shown, the cursor will “snap” to the boundaries of the elements on the page to make selecting a target asset easier. A uniquely colored border is then depicted to define the box 240. Clicking on the Click Here button 238 identifies the portion of the representation within the box as the target asset 242 and causes the interface to proceed to an option screen as illustrated in FIG. 4E.

The option screen contains a representation 250 of the target asset 242, a Add More to this Womp text 252, a Save button 254, option text 256 listing available options for monitoring the status of the target asset (e.g., Re-select the Womp area, Send to a friend, Notify Me if a Word changes or appears, Notify Me if a Word Changes or Appears, Change an RSS Feed, Create a WebSlice, Adding the Whomp to a forum or social networking page or forum), and check boxes 258 providing additional options (e.g., Add to home page, Make Mublic/Keep Private, Notify if Content (e.g., anything, number, word) changes, Notify by email and/or text message).

The representation 250 of the target asset may look very similar to the target asset as displayed on the target website or it may look different than the target asset as displayed on the target website. Although the representation 250 of the target asset may be desirable from the context of familiarity, it is also possible for the system to analyze the target asset and display information associated with the target asset in a unique way or in a standardized way to facilitate comparison with other target assets being monitored.

Clicking on the Add More Content button 252 allows the user to select additional target assets, while clicking on the Save button 254 saves state values and/or asset files associated with the target asset 242. The state values will be associated with numbers and/or words as chosen using the monitoring options, while the asset file will typically contain data from which the representation of the target asset 242 may be recreated.

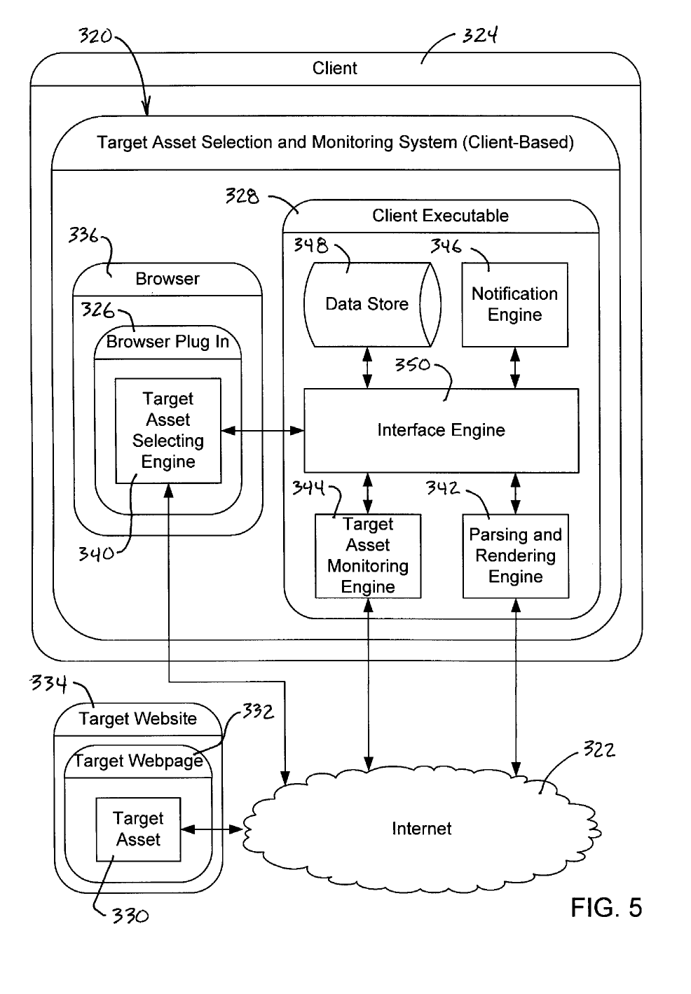

Turning now to FIG. 5, depicted therein is a third example of a target asset selection and monitoring system 320 constructed in accordance with, and embodying, the principles of the present invention. The example system 320 takes the form of a browser plug-in and executable program; the example system 320 will be referred to herein as a client-based target asset selection and monitoring system. More specifically, the system 320 is connected to a computer network 322 in the form of the Internet and runs on a client device 324. More than one client device 324 may be connected to the computer network 322 with capabilities similar to that of the example client device 324.

The example target asset selection and monitoring system 320 may be one single application or various pieces of software working together. As will be described in further detail below, the example system 320 is depicted as the combination a browser plug-in 326 and several separate engines forming an executable program 328.

FIG. 5 also illustrates a target asset 330. As generally discussed above, the computer network 322 will typically comprise many assets in addition to the target asset 330, but only the target asset 330 is illustrated in FIG. 5 for clarity. Additionally, two or more of the assets accessible using the computer network 322 may be target assets, but only one target asset is depicted in FIG. 5, again for purposes of clarity.

Commonly, the target asset 330 will form a part of a target webpage 332 that in turn forms a part of a target website 334. The target website 334 may comprise a plurality of webpages, but the target asset 330 is associated only with one of those webpages. However, a separate target asset may be identified with another of the webpages forming part of the target website 334.

The user 324 is configured as a computer running an industry standard browser program 336 configured to view the target website 334 and any target pages 332 and target assets 330 accessible on the target website 334.

The plug-in 326 is adapted to operate in conjunction with the browser 336; the plug-in 326 contains a target asset selecting engine 340. The target asset selecting engine 340 allows the user to browse for and select the target asset 330. The target asset selecting engine 344 also creates the target asset path for each target asset 330. The target asset path may include, but is not limited to, HTTP requests (POST, GET and possibly HEAD) to navigate to the target webpage 332 containing the target asset 330. The path to the target asset 330 may also include a method for locating the target asset 330 on the webpage 332. Methods for locating the target asset 330 on the target webpage 332 may include but are not limited to (these methods are also applicable to a server-based system):
1. crawling the page's Document Object Model to find one or more objects in the same location; and/or
2. locating the target asset by associating the target asset with the ID's of elements in or near the target asset on the Target Webpage.
Through the user interface presented by the plug-in 326, the user operates the target asset selecting engine 340 to select target assets 330.

The example executable program 328 is adapted to run on the user device 324 and comprises a parsing and rendering engine 342, a target asset monitoring engine 344, a notification engine 346, and a memory storage device in the form of a data store device 348.

The example target asset selection and monitoring system 340 further comprises an interface engine 350 that implements logic that allows the users 344 to operate the target asset selecting engine 340 and enter data for use by the parsing and rendering engine 342, target asset monitoring engine 344, notification engine 346, and data store 348. The example interface engine 350 also defines a user interface presented to the users 344.

The example interface engine 350 may also be configured to define a user interface (UI) presented to the users 324 and/or an application programming interface (API) for making functions of the system 320 available to third party applications. If a third party application accesses functions of the system 320 through an API defined by the interface engine 350, the users 324 may view a UI generated by the third party application and not the interface engine 350.

More specifically, the interface engine 350 may define a user interface that allows the users 324 to perform tasks including, but not limited to, the following tasks:
1 create an account (and/or become a member);
2. create or design a custom page containing one or more target assets 330; and/or
3. select how the user would like to increase their accessibility to target assets 330;

Through the user interface presented by the interface engine 350, the user operates the target asset selecting engine 340 to modify and delete target assets 330.

The parsing and rendering engine 342 generates a target asset file for each target asset selected or identified using the target asset selecting engine 340. The target asset file typically contains data corresponding to the look and feel of the target assets 330. The interface engine 350 may use the target asset file to generate at least a portion of the user interface presented to the user 324 such that at least a portion of the user interface represents and/or resembles the target asset 330. By presenting a user interface based at least in part on the target asset file, the interface engine facilitates the selection and monitoring of target assets 330.

The target asset monitoring engine 344 checks the status of each target asset by “scraping” the target assets associated with one or more users to obtain one or more state values associated with the target assets. The state values may be any quantity associated with a target asset, and examples of state values include the price of an item and the temperature of a geographical location.

The target asset monitoring engine 344 obtains one or more state values from each target asset at different points in time to allow the system 320 to determine whether the status of the target asset has changed. The target asset monitoring engine 344 may optionally store state values associated with target assets in the data store 348 for further analysis as will be described in further detail below.

Typically, the target asset monitoring engine 344 will scrape the target asset 330 at multiple points in time. As examples, the target asset monitoring engine 344 may scrape the target assets at a monitoring schedule based on a periodic interval specified by the user (e.g., every 5 or 30 minutes), specific times specified by the user (e.g. at 8 am and 31 am every weekday), and/or as determined by the engine 344.

The target asset monitoring engine 344 may be programmed to determine the optimum monitoring schedule for scraping a given target asset based on comparisons of state values associated with the target asset stored over time. For example, an analysis of state values over time may indicate that the status of a given target asset is more likely to change at a certain time of day, in which case the engine 344 will scrape the target asset shortly after that time each day. In another situation, the engine 344 might determine that the state values associated with a target asset are not changed in accordance with a predetermined schedule, and the values must be checked periodically. Accordingly, the engine 344 may be programmed to monitor target assets to create one or more monitoring schedules for each monitored target asset based on stored state values associated with the target assets.

In general, a comparison of a status value associated with a given target asset at a first point in time with the same status value of the given target asset at a second point in time allows the system 320 to determine whether the status of any given target asset 330 has changed. Typically, any change in the same status value between two different points in time will indicate that the status of the target asset has changed.

In the example system 320, the comparison of the state values may be performed by the target asset monitoring engine 344, by the notification engine 346, or by the interface engine 350. If the target asset monitoring engine 344 performs the comparison, the comparison will likely be performed in accordance with the user-defined or programmatically determined monitoring schedule. If the notification engine 346 performs the comparison, the comparison can be made according to a notification schedule. The notification schedule may be predetermined or defined by the user.

Once the system 320 determines that the status of the target asset has changed, the notification engine 346 will send a change notice to the user 324. The notification engine 346 can be programmed to send a change notice as soon as a change is detected or based on a notification schedule that can be predetermined or defined by the user.

In addition to the asset file and/or the state values, the data store 348 will typically store user information, such as email address, password, name, target asset information, such as target asset path, and any other information that needs to be persisted. The Data Store will typically be a database, text file, xml file, binary file, or the like.

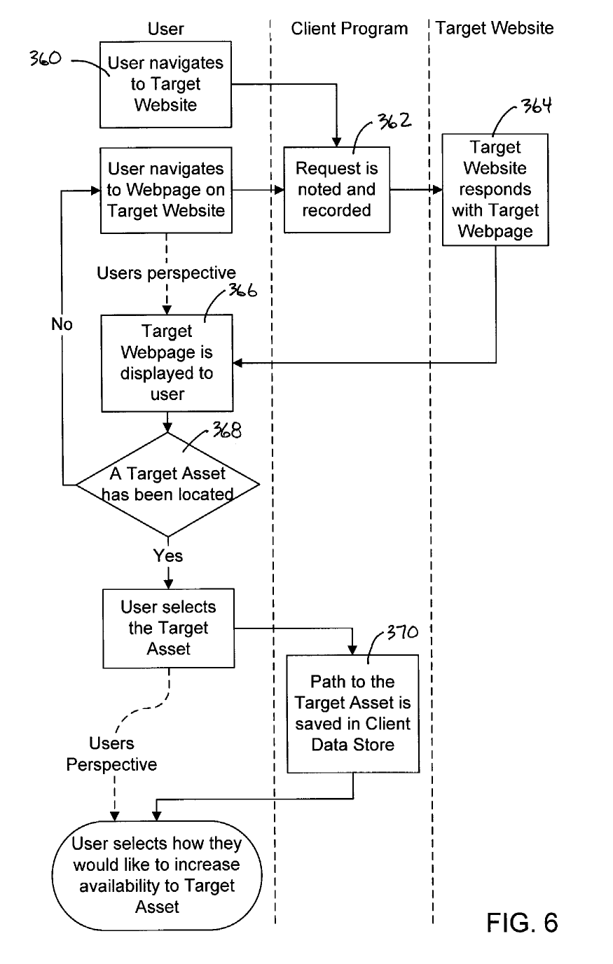

Referring now to FIG. 6, depicted therein is an example of a method of selecting a target asset that might be employed by a client-based target asset selection and monitoring system such as that depicted in FIG. 5 above. In this example, the term “client program” will be used to refer to a distributed executable containing a user agent (e.g., web browser, screen reader, mobile phone interface, etc.) or an addition/modification to an existing user agent (web browser plug-in. mobile phone add-on, etc.).

In a first step 360, a user uses the client program to navigate to a target website. Possible methods for navigating to a Target Website include clicking a link or entering the URL of the target website. At step 362, the client program records the URL of the target website as potentially becoming part of a target asset Path. At a step 364, the target website responds with target webpage, and the target webpage is displayed to the user at step 366.

At step 368, the user determines whether the desired target asset has been located. One possible method for allowing the user to indicate that a target asset has been found is to click a button in the user agent For example, a button may be provided by a Browser Helper Object, Browser Add-on, Browser Toolbar, or the like. If the user indicates that the target asset has not been located, the method returns to

If the user determines at step 368 that the target asset has been located, the user selects the target asset. Possible methods for selecting the target asset include clicking once on the target asset, clicking and dragging to select an area of the target webpage that contains the target asset, and/or indicating that the whole webpage is a target asset. At step 370, the client program saves the target asset path locally on the user's computer.

After the user has selected the target asset, the user is allowed to choose from among options determining how and when the system will notify the user of changes on the target asset. In the example method shown in FIG. 6, the client program provides an interface that allows the user to choose how they would like to increase the user's accessibility to the target asset.

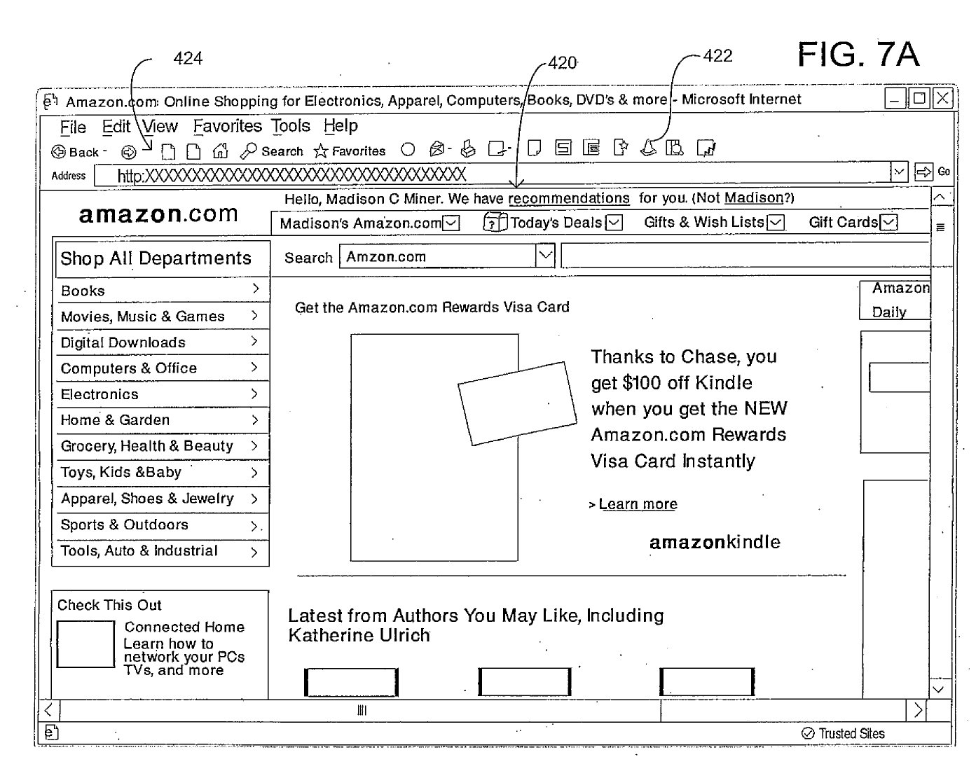

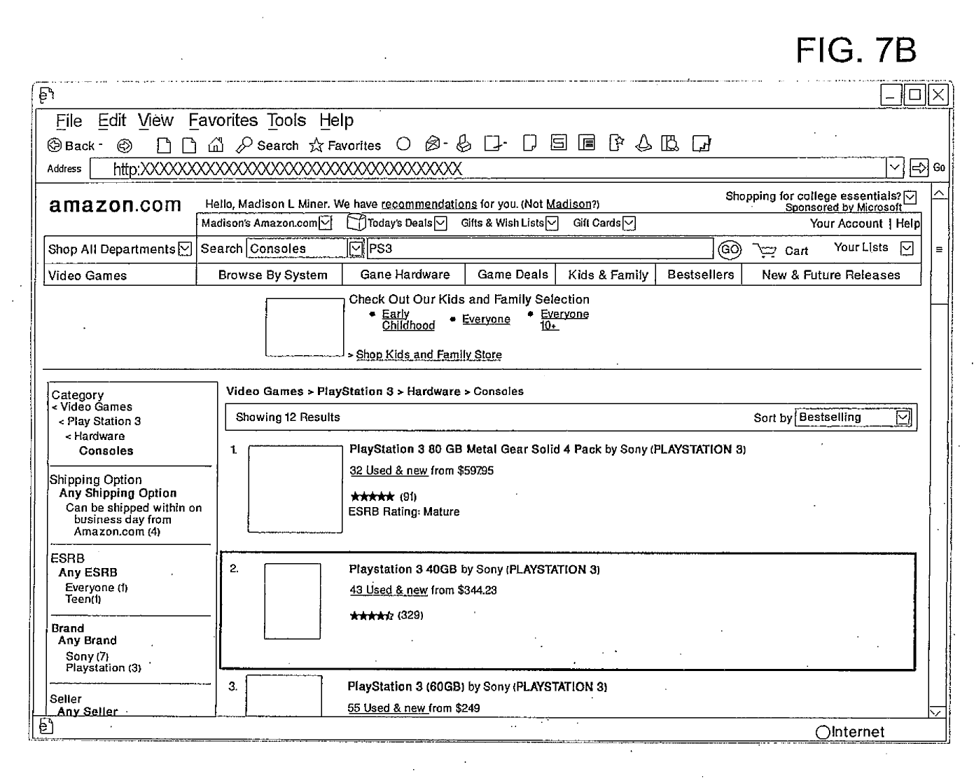

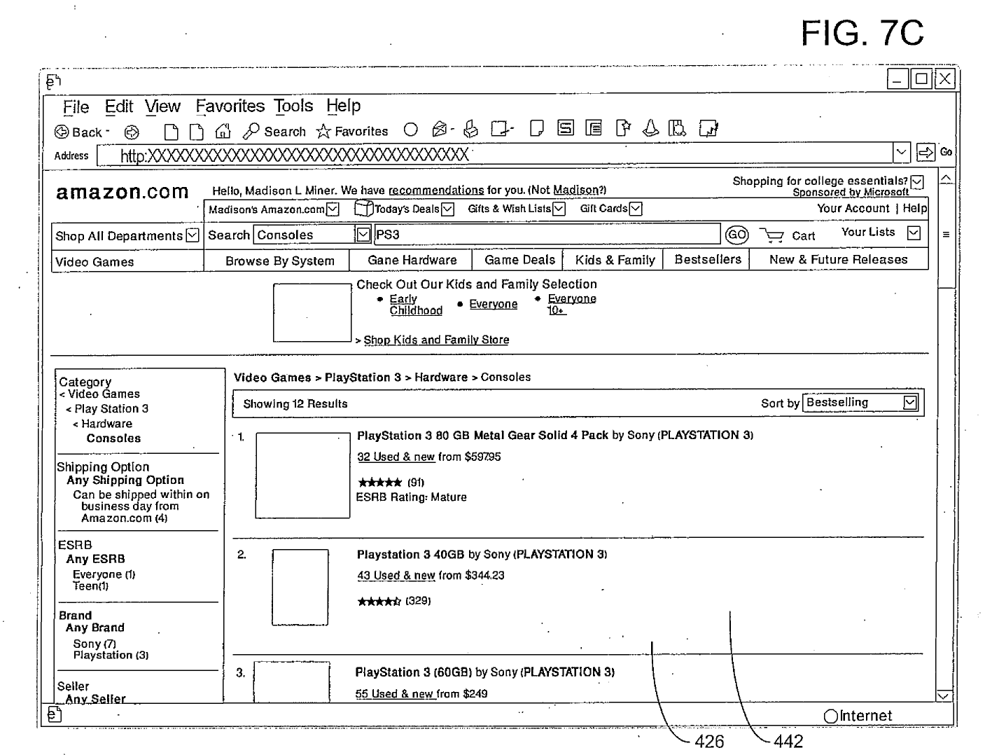

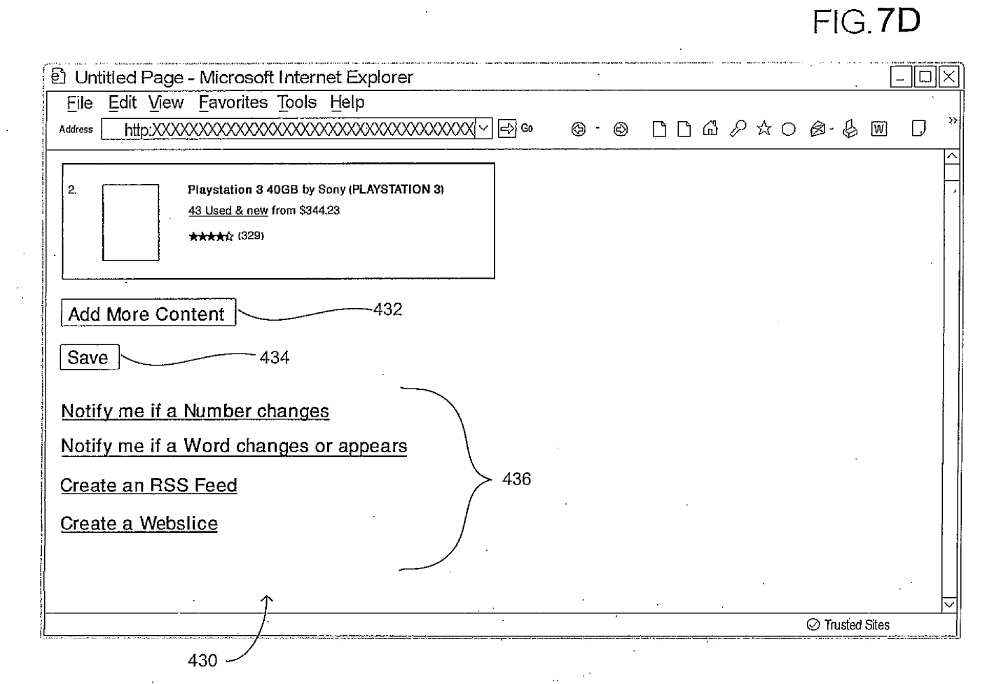

Turning now to FIG. 7A-7D of the drawing, depicted therein is another example interface configured to allow a user to select a target asset. The example interface depicted in FIGS. 7A-7D illustrates an example interface that may be implemented by a client-based system such as that depicted in FIG. 5.

Depicted at 420 in FIG. 7A is a navigation panel that is displayed when the user visits a target website using a user agent on the user's computer (e.g., web browser, screen reader, mobile phone interface, etc.) or using a user agent that contains an addition/modification that embodies the present invention (web browser plug-in, mobile phone add-on, etc.). The example screen shot depicting the navigation panel 420 shows the user visiting Amazon.com using Microsoft Internet Explorer and an Internet Explore plug-in. The plug-in adds a “traffic cone” button 422 to the Internet Explorer tool bar 424.

As shown in FIG. 7B, the user then navigates to the target webpage on the target website using the user agent, in this the plug-in equipped Internet Explorer. When the user views or locates a target asset to be monitored on the target webpage, the user indicates that a target asset has been located. In this example interface, the user indicates that the target asset has been located by clicking the “traffic cone” button 422 on the tool bar 424.

After the user has indicated that a target asset has been located, the user may select or otherwise more precisely identify the target asset as a portion of the target webpage. In this example interface, the user selects the target asset by clicking and dragging on the target webpage to select an area of the page containing the target asset. In the example shown in FIG. 7C, the cursor “snaps” to the boundaries of elements on the page to facilitate the selection of the target asset easier, but this is not a requirement. After the user has clicked and dragged and the cursor has “snapped” to the boundaries of the element forming the target asset, a uniquely colored blue border in the form of a box 426 is shown around the area the user has selected.

After the target asset has been identified as described above, the interface presents an options screen 430 as shown in FIG. 7D. A representation of the target asset is displayed on the options screen. The representation of the target asset that is displayed to the user may look very similar to the appearance of the target asset on the target webpage. Alternatively, the representation of the may look substantially different. For example, relevant elements of the target asset may be extracted and shown in a standardized form in a table.

The example option screen 430 further contains an Add More Content button 432, a Save button 434, and option text 436 listing available options for monitoring the status of the target asset (e.g., Notify Me if a Number Changes, Notify Me if a Word Changes or Appears) and for notifying the user if the status of the target asset changes (e.g., Create an RSS Feed, Create a WebSlice). Clicking on the Add More Content button 432 allows the user to select additional target assets, while clicking on the Save button 434 saves target asset path data, state values and/or asset files associated with the target asset. The state values will be associated with numbers and/or words as chosen using the monitoring options, while the asset file will typically contain data from which the representation of the target asset 442 may be recreated.

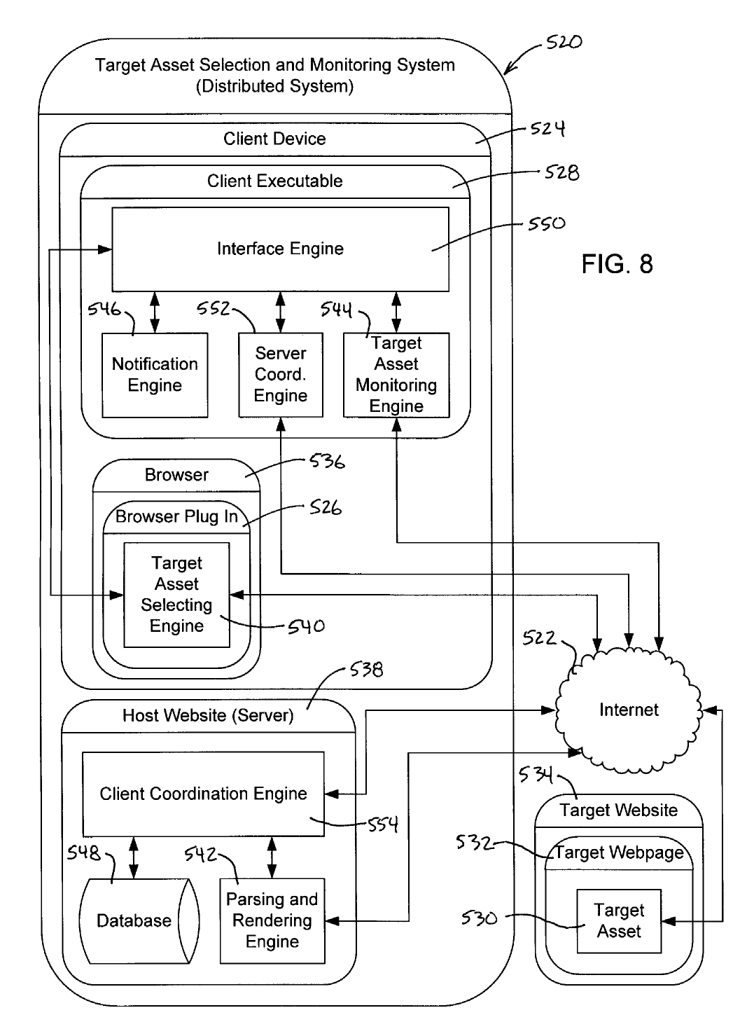

Turning now to FIG. 8, depicted therein is a fourth example of a target asset selection and monitoring system 520 constructed in accordance with, and embodying, the principles of the present invention. The example system 520 is connected to a computer network 522 in the form of the Internet and runs on a client device 524. The example system further comprises a plug-in 526 and a client executable 528. The example system 520 is a distributed system and will be referred to herein as a distributed target asset selection and monitoring system.

More than one client device 524 may be connected to the computer network 522 with capabilities similar to that of the example client device 524. FIG. 8 also illustrates that a target asset 530 is connected to the computer network 522. As generally discussed above, the computer network 522 will typically comprise many assets in addition to the target asset 530, but only the target asset 530 is illustrated in FIG. 8 for clarity. Additionally, two or more of the assets accessible using the computer network 522 may be target assets, but only one target asset is depicted in FIG. 8, again for purposes of clarity.

Commonly, the target asset 530 will form a part of a target webpage 532 that in turn forms a part of a target website 534. The target website 534 may comprise a plurality of webpages, but the target asset 530 is associated only with one of those webpages. However, a separate target asset may be identified with another of the webpages forming part of the target website 534.

The user 524 is configured as a computer running an industry standard browser program 536 configured to view the target website 534 and any target pages 532 and target assets 530 accessible on the target website 534.

The functions of the example target asset selection and monitoring system 520 are distributed among various pieces of software working together but running on different computing devices. As will be described in further detail below, the target asset selection and monitoring system comprises a portion running on the client device 524 and a portion running on a host website 538 that is also connected to the computer network 522.

The example host system 538 is adapted to be run on a remote server, and the example executable program 528 and the browser 536 (with plug-in 526) are adapted to run on the user device 524.

The target asset selection and monitoring system 520 further comprises a target asset selecting engine 540, a parsing and rendering engine 542, a target asset monitoring engine 544, a notification engine 546, and a data storage device in the form of a database 548.

The plug-in 526, which is adapted to operate in conjunction with the browser 536, contains the target asset selecting engine 540. The target asset selecting engine 540 allows the user to browse for and select the target asset 530. The target asset selecting engine 540 also creates the target asset path for each target asset 530. The target asset path may include, but is not limited to, HTTP requests (POST, GET and possibly HEAD) to navigate to the target webpage 532 containing the target asset 530. The path to the target asset 530 may also include a method for locating the target asset 530 on the webpage 532. Methods for locating the target asset 530 on the target webpage 532 may include but are not limited to:
1. using the physical (X, Y and Z) coordinates of the Target Asset on the Target Webpage;
2. using the HTML index associated with the target asset, name property, ID property, or other element attribute properties;
3. traversing the Document Object Model of the target webpage to find the target asset; and/or
4. locating static text in or around the target asset.

Through the user interface presented by the plug-in 526, the user operates the target asset selecting engine 540 to select target assets 530.

The example target asset selection and monitoring system 520 further comprises an interface engine 550, a server coordination engine 552, and a client coordination engine 554. The example interface engine 550 implements logic that allows the users 524 to operate the target asset selecting engine 540 and enter data for use by the parsing and rendering engine 542, target asset monitoring engine 544, notification engine 546, and data store 548.

The example interface engine 550 may also be configured to define a user interface (UI) presented to the users 524 and/or an application programming interface (API) for making functions of the system 520 available to third party applications. If a third party application accesses functions of the system 520 through an API defined by the interface engine 550, the users 524 may view a UI generated by the third party application and not the interface engine 550. The interface engine 550 may also provide a system and method for opening a web browser such as the browser program 536.

The example interface engine 550 defines a user interface that allows the users 524 to perform tasks including, but not limited to, the following tasks:
1. create an account (and/or become a member);
2. create or design a custom page containing one or more target assets 530; and/or
3. select how the user would like to increase their accessibility to target assets 530;

Through the user interface presented by the interface engine 550, the user operates the target asset selecting engine 540 to modify and delete target assets 530.

The server coordination engine 552 and client coordination engine 554 communicate over the network 522 to coordinate the operation of the components of the system 520.

The example parsing and rendering engine 542, which is part of the host website 538, generates a target asset file for each target asset selected or identified using the target asset selecting engine 540. The target asset file typically contains data corresponding to the look and feel of the target assets 530. The interface engine 550 may use the target asset file to generate at least a portion of the user interface presented to the user 524 such that at least a portion of the user interface represents and/or resembles the target asset 530. By presenting a user interface based at least in part on the target asset file, the interface engine facilitates the selection and monitoring of target assets 530.

The example target asset monitoring engine 544, which is part of the client executable 528, checks the status of each target asset by “scraping” the target assets associated with one or more users to obtain one or more state values associated with the target assets. The state values may be any quantity associated with a target asset, and examples of state values include the price of an item and the temperature of a geographical location.

The target asset monitoring engine 544 obtains one or more state values from each target asset at different points in time to allow the system 520 to determine whether the status of the target asset has changed. The target asset monitoring engine 544 may optionally store state values associated with target assets in the data store 548 for further analysis as will be described in further detail below.

Typically, the target asset monitoring engine 544 will scrape the target asset 530 at multiple points in time. As examples, the target asset monitoring engine 544 may scrape the target assets at a monitoring schedule based on a periodic interval specified by the user (e.g., every 5 or 50 minutes), specific times specified by the user (e.g. at 8 am and 51 am every weekday), and/or as determined by the engine 544.

The target asset monitoring engine 544 may be programmed to determine the optimum monitoring schedule for scraping a given target asset based on comparisons of state values associated with the target asset stored over time. For example, an analysis of state values over time may indicate that the status of a given target asset is more likely to change at a certain time of day, in which case the engine 544 will scrape the target asset shortly after that time each day. In another situation, the engine 544 might determine that the state values associated with a target asset are not changed in accordance with a predetermined schedule, and the values must be checked periodically. Accordingly, the engine 544 may be programmed to monitor target assets to create one or more monitoring schedules for each monitored target asset based on stored state values associated with the target assets.

In general, a comparison of a status value associated with a given target asset at a first point in time with the same status value of the given target asset at a second point in time allows the system 520 to determine whether the status of any given target asset 530 has changed. Typically, any change in the same status value between two different points in time will indicate that the status of the target asset has changed.

In the example system 520, the comparison of the state values may be performed by the target asset monitoring engine 544, by the notification engine 546, or by the interface engine 550. If the target asset monitoring engine 544 performs the comparison, the comparison will likely be performed in accordance with the user-defined or programmatically determined monitoring schedule. If the notification engine 546 performs the comparison, the comparison can be made according to a notification schedule. The notification schedule may be predetermined or defined by the user.

Once the system 520 determines that the status of the target asset has changed, the notification engine 546 will send a change notice to the user 524. The example notification engine 546, which is also part of the client executable 528, can be programmed to send a change notice as soon as a change is detected or based on a notification schedule that can be predetermined or defined by the user.

In addition to the asset file and/or the state values, the database 548 will typically store user information, such as email address, password, name, target asset information, such as target asset path, and any other information that needs to be persisted. The database 548 will typically be a database, text file, xml file, binary file, or the like. The example database 548 is maintained by the host website 538.

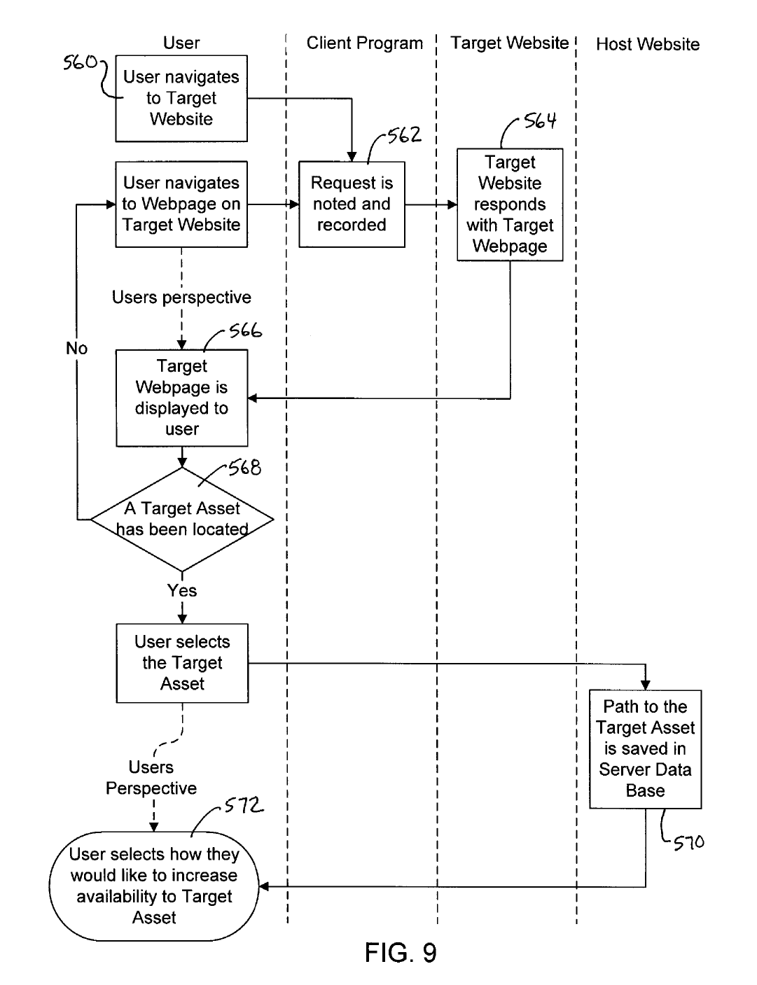

Referring now to FIG. 9, depicted therein is an example of a method of selecting a target asset that might be employed by a distributed target asset selection and monitoring system such as that depicted in FIG. 8 above. In a first step 560, a user uses the client program to navigate to a target website. Possible methods for navigating to a Target Website include clicking a link or entering the URL of the target website. At step 562, the client program records the URL of the target website as potentially becoming part of a target asset Path. At a step 564, the target website responds with target webpage, and the target webpage is displayed to the user at step 566.

At step 568, the user determines whether the desired target asset has been located. One possible method for allowing the user to indicate that a target asset has been found is to click a button in the user agent For example, a button may be provided by a Browser Helper Object, Browser Add-on, Browser Toolbar, or the like. If the user indicates that the target asset has not been located, the method returns to

If the user determines at step 568 that the target asset has been located, the user selects the target asset. Possible methods for selecting the target asset include clicking once on the target asset, clicking and dragging to select an area of the target webpage that contains the target asset, and/or indicating that the whole webpage is a target asset. At step 570, the client program saves the target asset path remotely in the database 548 located on the host website 538.

After the user has selected the target asset, the user is allowed to choose from among options determining how and when the system will notify the user of changes on the target asset at a step 572. In the example method shown in FIG. 9, the client program provides an interface that allows the user to choose how they would like to increase the user's accessibility to the target asset. The client program may also open a browser displaying a webpage from the host website that allows the user to choose how they would like to increase their accessibility to the target asset.

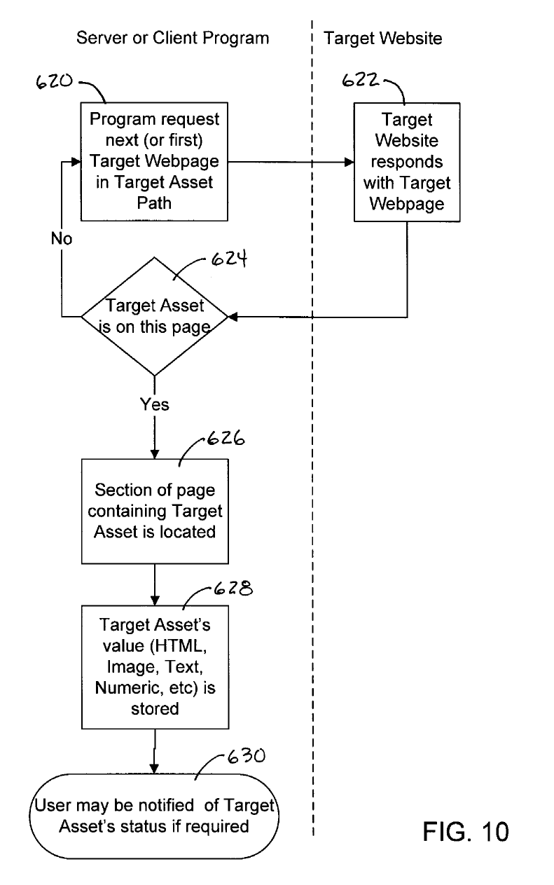

Turning now to FIG. 10, depicted therein is a flow diagram of a method for obtaining the status of a target asset using a server-based system, client-based system, or distributed system constructed in accordance with the principles of the present invention.

In a first step 620, the program requests the first (and possibly only) target webpage in a target asset path obtained from the target website. Requesting a target webpage may involve many different protocols, possibly including an HTTP GET action to request the target webpage or using an HTTP POST action to provide login information, conduct a search, and/or provide any other information.

At a step 622, the target website responds with the target webpage If the target asset is located on the requested target webpage at step 624, the program will attempt to find the target asset on the requested target webpage; if the target asset is not located on the requested target webpage, the program will return to step 620 and request the next target webpage in the target asset path.

At step 626, the program locates the section of the target webpage that contains the target asset. The target asset may be one element on the target webpage, multiple elements on the target webpage, or the entire target webpage. When the target asset is one or more HTML elements on a target webpage, the program may locate the target asset by using one of the following methods:
1. using the physical (X, Y and Z) coordinates of the Target Asset on the Target Webpage;
2. using the HTML index associated with the target asset, name property, ID property, or other element attribute properties;
3. traversing the Document Object Model of the target webpage to find the target asset; and/or
4. locating static text in or around the target asset.

At step 628, any relevant value associated with the target asset may be stored in a database and/or compared to earlier and later values and displayed to the user. The value of the target asset may represent a number, text, an image, a video, or the like.

At step 630, the program will review the user's settings and the current and historic values associated with the target asset to determine if the target asset has changed and the user should be notified. If the program determines that the user should be notified, the notification Engine may notify the user via email, text message, or the like.

From the foregoing, it should be apparent that the present invention may be embodied in forms other than those exact forms described above. In particular, alternate configurations of the systems and methods described above are also possible. For example, the notification engine and the monitoring engine of the system 620 may be located on the host website instead of on the client device.

Accordingly, the scope of the present invention should be determined by the claims appended hereto and not the foregoing detailed description of examples of the invention.

What is claimed is:

1. A system increasing accessibility to assets accessible on a computer network, comprising:
a plurality of target websites accessible over the computer network, where
the plurality of target websites are stored on a plurality of web servers connected to the computer network,
each of the plurality of target websites contains at least one target asset, and
each of the plurality of target websites defines an appearance of the target assets;
a target asset selecting engine connected to the computer network, where
the target asset selecting engine
allows at least one asset accessible over the computer network to be identified as a target asset,
generates target asset data associated with the at least one target asset, where the target asset data includes asset files associated with the appearance of the at least one target asset;
a memory storage device connected to the computer network, where the memory storage device stores the target asset data;
a rendering engine connected to the computer network, where
the rendering engine generates a target asset representation for each target asset based on the target asset data stored in the memory storage device, and
each target asset representation substantially matches the appearance of the target asset associated therewith; and
a plurality of computing devices connected to the computer network, where the computing devices allow the plurality of users to display the target asset representations.

2. A system as recited in claim 1, further comprising:
a target asset monitoring engine connected to the computer network, where the target asset monitoring engine monitors the at least one target asset for changes based on the target asset data stored in the memory storage device; and
a notification engine for notifying the at least one user of any changes in each target asset.

3. A system as recited in claim 2, in which the target asset monitoring engine compares state data associated with each target asset at an initial point in time with status data associated with each target asset at least one subsequent point in time.

4. A system as recited in claim 3, the target asset monitoring engine obtains status data at the at least one subsequent point in time based on a monitoring schedule.

5. A system as recited in claim 2, in which the target asset data further comprises state data, where the target asset monitoring engine monitors the at least one target asset for changes in the state data.

6. A system as recited in claim 1, further comprising an interface engine for allowing the at least one user to enter data.

7. A system as recited in claim 6, in which the interface engine defines a user interface accessible by the at least one user.

8. A system as recited in claim 6, in which the interface engine defines an application programming interface.

9. A system as recited in claim 1, in which the target asset selecting engine, the memory storage device, and the rendering engine run on at least one server connected to the computer network, where the at least one server is remote from the user computing device.

10. A system as recited in claim 1, in which:
at least one server is connected to the computer network, where the at least one server is remote from the user computing devices;
wherein
at least one of the target asset selecting engine, the memory storage device, and the rendering engine run on the computer using device; and
at least one of the target asset selecting engine, the memory storage device, and the rendering engine run on the server.

11. A system for increasing accessibility to target assets associated with a target webpage accessible over a computer network, comprising:
a target asset selecting engine that
generates a representation of the target webpage containing the target asset,
allows a portion of the target webpage to be selected as the target asset based on the representation of the target webpage, and
generates target asset data associated with the target asset, where the target asset data includes asset files associated with the appearance of the target asset;
a memory storage device for storing the target asset data; and
a rendering engine connected to the computer network, where
the rendering engine generates a target asset representation for each target asset based on the target asset data stored in the memory storage device, and
each target asset representation substantially matches the appearance of the target asset associated therewith.

12. A system as recited in claim 11, in which the target asset data comprises state data, the system further comprising:a target asset monitoring engine that
generates, based on the state data, first and second state value sets each comprising at least one state value associated with the state data, and
compares the first and second state value sets to determine whether a state of the target asset has changed;
a notification engine for notifying the user when the target asset monitoring engine determines that the state of the target asset has changed.

13. A system as recited in claim 12, in which the target asset monitoring engine obtains the first and second state value sets at different points in time.

14. A system as recited in claim 13, the target asset monitoring engine obtains state value sets based on a monitoring schedule.

15. A system as recited in claim 11, further comprising an interface engine for allowing the user to enter data.

16. A system as recited in claim 15, in which the interface engine defines a user interface accessible by the user.

17. A system as recited in claim 15, in which the interface engine defines an application programming interface.

18. A system as recited in claim 11, in which:
the plurality of users each operate at least one user computing device connected to the computer network; and
the target asset selecting engine, the memory storage device, and the rendering engine run on at least one server connected to the computer network, where the at least one server is remote from the user computing devices.

19. A system as recited in claim 11, in which:
the plurality of users each operate at least one user computing device connected to the computer network; and
the target asset selecting engine, a memory storage device, and a rendering engine run on the user computer device.

20. A system as recited in claim 11, in which:
the plurality of users each operate at least one user computing device connected to the computer network;
at least one server is connected to the computer network, where the at least one server is remote from the user computing device;
at least one of the target asset selecting engine, the memory storage device, and the notification engine run on the user computer device; and
at least one of the target asset selecting engine, the memory storage device, and the notification engine run on the server.
